(19) United States
(12) Patent Application Publication
(10) Pub. No.: US 2004/0195727 A1
(43) Pub. Date: Oct. 7, 2004

(54) Knee Meniscus implant

(75) Inventor: George P. Stoy, Boro of Rocky Hill, NJ (US)

Correspondence Address: Kenneth P. Glynn, Esq., Glynn & Associates, P.C., 24 Mine Street, Flemington, NJ, 08822, US

(73) Assignee: PRAGTECH, INC.

(21) Appl. No.: 10/829,696

(22) Filed: Apr. 22, 2004

Related U.S. Application Data
(63) Continuation of application No. 10/267,324, filed on Oct. 9, 2002.

(51) Int. Cl. B29C 39/00

(52) U.S. Cl. 264/319

(57) ABSTRACT

The present invention is a method of making a lubricious polyacrylonitrile knee meniscus implant of a predetermined form and the resulting product. The method includes preparing a solution of a room temperature solvent that will dissolve polyacrylonitrile at room temperature and a room temperature non-solvent that will not dissolve polyacrylonitrile at room temperature. The solution is prepared with sufficient non-solvent to render the room temperature solvent inoperable for polyacrylonitrile at room temperature and operable at temperatures above 65° C. to dissolve polyacrylonitrile therein. Next, the polyacrylonitrile and the solution are combined into a mixture, in an amount of at least 20%, by weight, of polyacrylonitrile. The mixture is then heated at temperatures in excess of 65° C. to produce a fluid polyacrylonitrile product, and processed into an artificial joint component mold. Next, the product is cooled and may be rinsed, solvent extracted and dried. It is then optionally, but preferably, treated chemically, e.g. with sulfuric acid, to increase hydrophilicity, and lubricity.

### REFERENCE TO RELATED APPLICATION

This patent application is a continuation-in-part of United States copending application Ser. No. 10/267,324 filed on Oct. 9, 2002, entitled “Method Of Making Lubricious Polyacrylonitrile Artificial Joint Components And Resulting Products”, by the same inventor and assignee herein.

### BACKGROUND OF THE INVENTION

1. Field of the Invention

The present invention relates to a method of making polyacrylonitrile (“PAN”) artificial knee meniscus implants and to the knee meniscus implant products resulting therefrom. More specifically, it relates to a method of processing PAN into knee meniscus implants using significantly less solvent while creating artificial these products with superior physical characteristics. The present invention also relates to the lubricious polyacrylonitrile knee meniscus implant products made by the process.

2. Information Disclosure Statement

The following patents relate to the processing of polyacrylonitriles, or the preparation of artificial implants:

U.S. Pat. No. 4,344,193 describes a meniscus prosthetic device for a human knee joint that can be inserted into the knee joint so that the articulating cartilage in the knee totally remains intact. The prosthesis device translates between the articulating cartilage during normal knee movement. Insertion of the prosthetic device is accomplished by applying force on the ends of the device, thereby elastically spreading them, and placing the device between the tibial articulating cartilage and one of the femoral condyles. The forces thus applied can then be released causing the device to conform to its original C-shape. Prominences on the ends of the device may superiorly extended into the space defined by the femoral condyles, thereby securing the device in place.

U.S. Pat. No. 4,369,294 discloses block copolymers having acrylonitrile sequences and sequences of glutarimide units of a molecular weight of from about 10,000 to about 2,000,000 where the acrylonitrile sequences and sequences including glutarimide units are of molecular weight of at least about 400 with the number of sequences being at least about 2 and preferably 5 and higher.

U.S. Pat. No. 4,502,161 describes a prosthetic meniscus that replaces the natural meniscus and is located between the natural articular surfaces of the bones of a joint. The prosthetic meniscus includes a body portion formed of a resilient material and further defines an extra-articular extension which is attached to the surface of the bone outside the joint. A reinforcing fabric or mesh is embedded in the resilient material to give the meniscus strength and shape. A meniscus according to the invention allows full articulation of the joint and provides the cushioning and lubricating functions of a natural meniscus while avoiding problems associated with total joint replacement.

U.S. Pat. No. 4,731,078 describes an artificial intraocular lens that features an optical body for refracting images onto the retina and an outer surface that encloses that optical body, is exposed to fluid within the eye, and has a refractive index no greater than 1.40. In another aspect, the optical body includes an internal refractive surface whose contour can be selectively changed to change its refractive power.

U.S. Pat. No. 4,731,079 describes a novel intraocular lens and mode of insertion therefore. The lens is of conventional shape and dimensions but is made of polymeric material having a softening point in the range of body temperature. The lens, prior to insertion is dimensionally reduced to enable introduction through a small incision by compression or by axial extension. The deformed lens is frozen in this configuration by cooling the lens below its softening temperature. The cooled, deformed lens is then inserted into the eye. The action of body heat, optionally supplemented by various non-harmful methods, permits the lens to regain its original configuration within the eye.

U.S. Pat. No. 4,943,618 describes a method that is disclosed for preparing polyacrylonitrile copolymers by Heterogeneous reaction of polyacrylonitrile aquagel. Generally, the method includes the steps of preparing a solution of polyacrylonitrile by dissolving the polyacrylonitrile in a water-miscible solvent which is capable of dissolving the polyacrylonitrile but incapable of hydrolyzing the nitrile groups of the polyacrylonitrile but incapable of hydrolyzing the nitrile groups of the polyacrylonitrile under the dissolution conditions. Coagulating the polyacrylonitrile solution by replacing the solvent with a coagulating fluid such as water or a water miscible fluid incapable of dissolving polyacrylonitrile at temperatures below 80° C., and incapable of reacting with nitrile groups of the polyacrylonitrile, thus obtaining the polymer in the aquagel state. Replacing the coagulating fluid with a fluid reagent capable of reacting with nitrile groups of the polyacrylonitrile aquagel but incapable of dissolving the polyacrylonitrile aquagel at the selected reaction temperature. Allowing the fluid reagent to chemically react with the nitrile groups of the aquagel while the polyacrylonitrile aquagel is undissolved to form a copolymer product. The copolymer product is then either used in further chemical reactions involving newly formed and/or original side substituents, or isolated and utilized for molding or shaping into various articles. Various plasticizers, which when undiluted are capable of dissolving polyacrylonitrile, may be added to the copolymer product to assist in molding or shaping the material into an article.

U.S. Pat. No. 4,944,758 describes an artificial joint comprising a first member including a butt portion located at one end of the first member and having an internal opening and a long guide groove extending to the opening and a second member in contact with the butt portion of the first member and including an expanded portion at one end of the second member. The expanded portion is fitted in the internal opening of the first member. A projection along both sides of the long guide groove prevents the expanded portion from separating from the internal opening except at prescribed positions of the first and second members, the long guide groove guides the movement of the second member as it bends relative to the first member in a prescribed direction.

U.S. Pat. No. 5,007,934 describes a prosthetic, resorbable meniscus and method of its fabrication. The prosthetic meniscus can be implanted in a human knee where it can act as a scaffold for regrowth of native meniscal tissues. The meniscus comprises a dry, porous, matrix of biocompatible and bioresorbable fibers, at least a portion of which may be crosslinked. The fibers include natural polymers or analogs or mixtures thereof. The matrix is adapted to have in vivo an outer surface contour substantially the same as that of a natural meniscus. The matrix has pore size in the approximate range of greater 50 microns to less than about 500 microns. With this configuration, the matrix establishes an at least partially bioresorbable scaffold adapted for ingrowth of meniscal fibrochondrocytes.

U.S. Pat. No. 5,092,896 describes a finger joint prosthesis that is provided which consists of two pegs of sintered hydroxylapatite for anchoring in adjacent finger bones and which is provided with an intermediate slide layer of polyurethane between the pegs to permit relative movement there between. The pegs together with the intermediate layer which may be anchored on one of the pegs form concave and convex bearing areas mating with each other to allow a guided motion in the bend-stretch plane.

U.S. Pat. No. 5,116,374 describes a prosthetic, resorbable meniscus and method of its fabrication. The prosthetic meniscus can be implanted in a human knee where it can act as a scaffold for regrowth of native meniscal tissues. The meniscus comprises a dry, porous, matrix of biocompatible and bioresorbable fibers, at least a portion of which may be crosslinked. The fibers include natural polymers or analogs or mixtures thereof. The matrix is adapted to have in vivo an outer surface contour substantially the same as that of a natural meniscus. The matrix has pore size in the approximate range of greater than 50 microns to less than about 500 microns. With this configuration, the matrix establishes an at least partially bioresorbable scaffold adapted for ingrowth of meniscal fibrochondrocytes.

U.S. Pat. No. 5,149,052 describes a method and apparatus for precision molding soluble polymers is disclosed, in order to form an exact and precisely shaped product, such as contact lenses and surgical implants. A preferred mold for forming contact lenses includes a female part having an indentation and a sharp circumferential edge surrounding the indentation. The mold also includes a male part which is adapted to contact the sharp circumferential edge of the female part to form the molding cavity between the indentation of the female part and the male part. A semi-permeable gate is formed between the female part and the male part for introducing coagulating fluid into the molding cavity while preventing the escape of the polymer solution from the molding cavity. The semi-permeable gate allows the diffusion of the coagulating fluid into the molding cavity at a faster rate than the rate of diffusion of solvent out of the molding cavity. The polymer solution is coagulated by the influx of the coagulating fluid into the polymer solution which causes both the coagulation and swelling of the polymer solution. Swelling of the polymer solution coagulates the solution under pressure within the molding cavity to form a precisely shaped product. Coagulation proceeds under pressure since the solvent diffuses out of the semi-permeable gate at a slower rate than the diffusion of the coagulating fluid into the molding cavity.

U.S. Pat. No. 5,159,360 describes a contact lens that is a soft, disposable lens which, under eye wearer conditions, changes one or more characteristics essential for comfortable use, at a predetermined time to initiate disposal thereof by the user. This lens, under wear conditions, changes, for example, at least its base curve redius and its deformability as a consequence of a change in hydrophilicity of at least a portion of the contact lens material. This hydrophilicity change may be achieved by various means, e.g. degradation of crosslinking bridges or conversion of less hydrophilic groups to groups having greater hydrophilicity. In one preferred embodiment, the conversion is achieved by hydrolysis of selected functional (hydrophobic) groups into hydrophilic groups.

U.S. Pat. No. 5,217,026 describes a guidewire that involves an elongated, non-hydrogel core element forming an inner part of the device, and an integral outside tubular layer of elastomeric hydrogel (“hydrogel sleeve”). This outer hydrogel layer has unique physical characteristics. They are (a) Gradient of chemical composition with increasing concentration of polar groups in the outward direction away from the core element; (b) Gradient of swelling in contact with water with water content increasing in the outward direction away from the core element; (c) Compressive stress in the outer hydrophilic layer causing the hydrogel in that layer to swell to a water content and, optionally, (d) Inward-directed radial stress pushing the outside hydrogel layer constantly against the inner core element. The present invention also involves the methods of making these guidewires, including melt extrusion directly onto the core element, coagulation from solution, in situ hydrogel polymer formation, and tubing extrusion followed by consequent shrink-fit over the core.

U.S. Pat. No. 5,218,039 describes stable emulsions and dispersions of both the water-in-oil and oil-in-water types that are prepared by subjecting mixtures of the two phases to shear stress in the presence of nitrile group-containing copolymers capable of forming hydrogels containing at least 90%, by weight, of water at room temperature.

U.S. Pat. No. 5,368,048 describes a method of making a radio-opaque tipped, sleeved guidewire. It includes providing a bendable core piece of a predetermined length, having a control end and having a predetermined core diameter, and providing a shrinkable polymeric sleeve formed of a first polymer composition having a first diameter at least as large as said core diameter and having a second, smaller diameter from shrinking said second diameter, which is less than said core diameter. The polymeric sleeve is placed over the core piece while the polymeric sleeve has its first diameter, so as to have one end of the polymeric sleeve cover at least a portion of the distal end of the core piece. Next, a mixture of a radio-opaque metal powder and a second polymer composition is provided. The second polymer composition is capable of forming a physical bond with the first polymeric composition of the polymeric sleeve. The mixture is inserted into the overhanging polymeric sleeve at the distal end of the core piece and the polymeric sleeve is shrunk to its second, smaller diameter. The physical bond is formed between the first polymer composition and the second polymer composition. The present invention is also directed to the resulting guidewire products.

U.S. Pat. No. 5,425,777 describes a metallic implantable finger joint that has a biocompatible protective coating and includes both a base member and a protraction member. The base member is formed with a recess and has a protrusion projecting from inside the recess. The protraction member has a hemispherical surface which is slidingly engageable with the recess of the base member. Additionally, the protraction member is formed with a groove which engagingly receives the protrusion from the base member. This engagement is such that when the base member is juxtaposed with the protraction member, the interaction between the protrusion and the groove allows for relative movement between the members in flexion-extension, lateral rotation and pure rotation. The finger joint can also include implant barbs which are selectively engageable with the base member and the protraction member.

U.S. Pat. No. 5,549,690 describes a method for molding a prosthetic CMC thumb joint, and the joint manufactured therefrom, involves anatomically locating the two non-perpendicular and non-intersecting axes of rotation for the joint. The surface of revolution about these two axes, which is a torus, is then used to mathematically model the bearing surfaces of the prosthetic joint.

U.S. Pat. No. 5,578,086 describes a non-percutaneous prosthesis, reconstuctive sheeting and composite material which exhibit excellent tissue adhesion, outstanding biocompatibility, moldability, trimability and flexibility are disclosed. The non-percutaneous prosthesis, reconstructive sheeting and composite material can be easily molded into various shapes, trimmed with a scalpel and deformed during prosthesis positioning. The non-percutaneous prosthesis comprises a biocompatible composite material which is made of an elastomeric material and bio-active ceramic or glass particles and has a predetermined shape. The bio-active ceramic or glass particles are dispersed throughout a matrix of the elastomeric material having a predetermined shape, or the elastomeric material is formed to the predetermined shape and the bio-active ceramic or glass particles are coated on a surface of the elastomeric material. In another embodiment, the non-percutaneous prosthesis comprises a base material of predetermined shape and a layer of elastomeric material provided on the base material, wherein a layer of elastomeric material has distributed therein or provided thereon bio-active ceramic or glass particles. The elastomeric material is preferably one of silicone, polyurethane and its derivatives, hydrogel and C-Flex® and, more preferably, is silicone or hydrogel. The bio-active ceramic or glass particles are preferably made of hydoxylapatite. The reconstructive sheeting comprises a biocompatible composite material made of an elastomeric material and bio-active ceramic or glass particles. Also, the present invention provides a biocompatible composite material comprising hydrogel and particles of a bio-active ceramic or glass material. The particles are preferably dispersed throughout a matrix of hydrogel.

U.S. Pat. No. 5,728,157 describes a non-resorbable flexible prosthesis that includes a composite made of an elastomeric matrix and a plurality of hydroxylapatite particles dispersed throughout the matrix. The hydroxylapatite particles form about 25%-70%, by weight, of the prosthesis. The matrix is cured to form a flexible prosthesis such that an applied force can distort the flexible prosthesis from its original shape and the flexible prosthesis will substantially return to its original shape when the applied force is removed.

U.S. Pat. No. 6,027,744 describes a method for generating new tissue, the method including: obtaining a liquid hydrogel-cell composition including a hydrogel and tissue precursor cells; delivering the liquid hydrogel-cell composition into a permeable, biocompatible support structure; and allowing the liquid hydrogel-cell composition to solidify within the support structure and the tissue precursor cells to grow and generate new tissue. The invention also features a tissue forming structure including: a permeable, biocompatible support structure having a predetermined shape that corresponds to the shape of desired tissue; and a hydrogel-cell composition at least partially filling the support structure, wherein the hydrogel-cell composition comprises a hydrogel and tissue precursor cells.

U.S. Pat. No. 6,132,468 describes a flexible “scaffold” envelop which can be used to replace damaged cartilage in knees, shoulders, or other joints of a mammalian body. Designed for use in arthroscopic surgery, the envelope is sufficiently flexible to allow it to be rolled up or folded and inserted into a knee or other joint via a small skin incision. Before insertion, a segment of damaged cartilage is removed from a bone surface, and the bone surface is prepared, using various tools and alignment guides disclosed herein. After the envelope is inserted into joint, it is unfolded, positioned properly, and anchored and cemented to a bone surface. After anchoring, the envelope is filled via an inlet tube with a polymeric substance that will set and solidify at body temperature. During filling and setting, the surgeon can manipulate the exterior shape of the scaffold envelope, to ensure that the implant will have a proper final shape after the polymer has cured into fully solidified form. Using these materials and methods, a synthetic replacement can be created for damaged or diseased cartilage, having a smooth surface and a non-rigid stiffness closely resembling natural cartilage. The entire procedure can use minimally invasive tools and methods, to avoid having to cut open and fully expose a joint that is being repaired. Various devices and methods are disclosed to facilitate this procedure, including tools and devices to help ensure proper arthroscopic preparation of large bone surfaces, and proper positioning, alignment, anchoring, and filling of a scaffold envelope.

U.S. Pat. No. 6,168,626 describes an ultra high molecular weight polyethylene molded article for artificial joints that has molecular orientation or crystal orientation in the molded article, and is low in friction and is superior in abrasion resistance, and therefore is available as components, for artificial joints. Further, the ultra high molecular weight polyethylene molded article for artificial joints can be used as a component for artificial hip joints (artificial acetabular cup), a component for artificial knee joints (artificial tibial insert) and the socket for artificial elbow joints, and in addition to the medical use, it can be applied as materials for various industries by utilizing the characteristics such as low friction and superior abrasion resistance.

U.S. Pat. No. 6,383,223 describes, in an endoprosthesis for a joint, the two interacting joint parts are joined by a cord-type connection piece, which is attached in the vicinity of the body axis of the convex condyle and extends through a longitude groove in the flexion direction of the joint. The connection piece assures a play space between the contact surfaces of joint. It is protected from friction on groove wall by an elevation in concave joint part. An elevation at concave joint part and a depression at convex joint part interact in such a way that the lateral movement play space between depression and elevation determines the freedom of movement with respect to the lateroflexion of the joint. In preferred forms of embodiment, thanks to spherical surfaces at least one pair of corresponding sliding surfaces on the two condyles lie flatly on one another, under load, in any position of the joint.

U.S. Pat. No. 6,386,877 describes the implant that has an anchoring part with an axis, a general cylindrical section and a peripheral surface. The latter is provided, in the generally cylindrical section, with protuberances which are distributed around the axis. At least the majority of these protuberances are elongate and parallel with the axis and have at least one terminal surface which is contiguous with a recess having a base formed by the peripheral surface. In this way, the anchoring part can be pushed into a substantially cylindrical hole in a one such that the implant is immediately anchored in the bone in a stable manner, said implant nevertheless having a high degree of strength.

U.S. Pat. No. 6,530,956 B1 describes a load-sharing resorbable scaffold that is used to help transplanted chondrocytes or other cells generate new cartilage in a damaged joint such as a knee, hip, or shoulder. These scaffolds use two distinct matrix materials. One is a relatively stiff matrix material, designed to withstand and resist a compressive articulating load placed on the joint during the convalescent period, shortly after surgery. Due to the requirement for relatively high stiffness, this material must be denser and have less pore space than other matrices, so it will not be able to support highly rapid cell proliferation and cartilage secretion. The second material comprises a more open and porous matrix, designed to promote maximal rapid generation of new cartilage. In one preferred geometric arrangement, the stiffer matrix material is used to provide an outer rim and one or more internal runners, all of which can distribute a compressive load between them. The rim and runners create a cluster of internal cell-growing compartments, which are filled with the porous and open matrix material to encourage rapid cell reproduction and cartilage generation. These improved scaffolds can also have an articulating outer membrane with certain traits disclosed herein, bonded to and resting upon the upper edges of the runners and rim. The scaffold will support the membrane with a degree of stiffness and resiliency that allows the membrane to mimic a healthy cartilage surface. These scaffolds can be made of flexible materials, to allow them to be inserted into a damaged joint using arthroscopic methods and tools.

U.S. Pat. No. 6,629,997 B2 a device for surgical implantation to replace damaged tissue in a joint (such as a meniscus in a knee) that is created from a hydrogel and is reinforced by a three-dimensional flexible fibrous mesh. In a meniscal implant, the mesh is exposed at one or more locations around the periphery, to provide anchoring attachment that can be sutured, pinned, or otherwise securely affixed to tissue that surrounds the implant. The fibrous mesh should extend throughout most of the thickness of the hydrogel, to create an “interpenetrating network” (IPN) of fibers modeled after certain types of natural body tissues. Articulating surfaces which will rub and slide against cartilage should be coated with a hydrogel layer that is completely smooth and nonabrasive, and made of a material that remains constantly wet. This composite structure provides a meniscal implant with improved strength, performance, and wettability compared to implants of the prior art. This type of implant may also be useful in repairing other joints, such as shoulders, wrists, ankles, or elbows, and in repairing injured or diseased hands, fingers, feet, or toes.

United States Patent Application Publication No. 2001/0025199 describes the invention that shows an artificial finger joint comprising a convex joint head and comprising a concave joint shell which can be fastened independently of one another with a respective shaft in a bone end and which can be moved in an articulation plane from an extension position with parallel shaft axes into a hyperextension position or into an articulation end position. A guide pin projects out of the joint shell in the direction of its shaft axis and protrudes into a pocket of the joint head with the pocket having a first abutment for the guide pin in the hyperextension position. A second abutment between the joint shell and the joint head prevents a tilting of the guide pin and shaft of the joint shell about the first abutment in the hyperextension position.

Notwithstanding the prior art, the present invention is neither taught nor rendered obvious thereby.

### SUMMARY OF THE INVENTION

The present invention involves a method of making a lubricious polyacrylonitrile knee meniscus implant of a predetermined form and the product resulting therefrom. The first step in this method includes preparing a solution of a room temperature solvent that will dissolve polyacrylonitrile at room temperature and, a room temperature non-solvent that will not dissolve polyacrylonitrile at room temperature. The solution is prepared with sufficient non-solvent to render the room temperature solvent inoperable such that it will not dissolve polyacrylonitrile at room temperature and such that it will be operable at temperatures above 65° C. to dissolve polyacrylonitrile therein. The second step in the present invention method involves combining polyacrylonitrile with the solution to form a mixture, in an amount of at least 20%, by weight, of polyacrylonitrile, based on the total weight of the mixture. Preferred is about 20% to about 50% by weight of the polyacrylonitrile.

The third step involves heating the mixture at temperatures in excess of 65° C. to produce a fluid polyacrylonitrile product and processing the fluid polyacrylonitrile product in a mold of the desired form of the artificial joint component. The mold may be heated and/or under pressure, and compression molding is preferred. Two piece molds are generally used to permit easy removal of the product. Next, the product is cooled and may be rinsed, solvent extracted and dried. It is then treated chemically, e.g. with sulfuric acid, to increase hydrophilicity, and lubricity.

An optional and preferred step, which is useful in forming medical devices and related products, involves extracting solvent from the product by liquid extraction, e.g. warm water wash.

The room temperature solvent is selected from any solvent strong or weak, that will dissolve PAN at room temperature, these include dimethyl sulfoxide, dimethyl formamide, NaSCN, CaSCN, nitric acid, ethylene carborate and mixtures thereof, although others may be used. The present invention process non-solvent may be any which function to render the room temperature solvent useless as a solvent for PAN at room temperature, but will permit that solvent to function at elevated temperatures. The non-solvent may be selected from the group consisting of water, liquid carbon compounds that do not dissolve polyacrylonitrile, and combinations thereof. The carbon compounds may be selected from the group consisting of liquid straight chain hydrocarbons, liquid ring hydrocarbons, liquid ring-straight chain hydrocarbons, and mixtures thereof. The non-solvent may also be selected from the group consisting of glycol, liquid alcohols, liquid ketones, and combinations thereof. In general, the solvent solution is achieved by simply mixing the solvent and non-solvent, at room or elevated temperature, and the components should be miscible with one another.

The solution preferably contains about 40% to 98% of the room temperature solvent and about 60% to 2% of the room temperature non-solvent, by weight, based on the weight of the room temperature solvent and the room temperature non-solvent. More preferably, the solution contains at least 50%, by weight, of room temperature solvent, based on the weight of the room temperature solvent and the room temperature non-solvent.

The mixture processing step following the mixing of the solution and the polyacrylonitrile could involve cold molding or casting or the like, or it could be a processing step in a hot-melt processor, such as injection molding, compression molding and hot casting.

In preferred embodiments of the present invention, the step (b) PAN is granular (i.e. powder) polyacrylonitrile, and the resulting mixture of the process is in flake form.

The knee meniscus implant products resulting from the methods above are also part of the invention herein.

### BRIEF DESCRIPTION OF THE DRAWINGS

The present invention should be more fully understood when the specification herein is taken in conjunction with the drawings appended hereto wherein:

FIGS. 1A and 1B illustrate a present invention hydrogel disc, with one side flat, and the other side concave.

FIGS. 2A and 2B show the disc as in FIGS. 1A and 1B, except wherein these Figures show a cut “horseshoe section” knee meniscus implant.

FIGS. 3A and 3B illustrate a sandwiched structure of a present invention knee meniscus disc.

FIGS. 4A and 4B show a present invention hydrogel disc wherein a high density hydrogel forms top concave layer, and low density hydrogel forms flat, bottom layer

### DETAILED DESCRIPTION OF THE PRESENT INVENTION

The frequency and severity of injuries to the knee joint have increased considerably over the past years. Statistically the main causes are sport injuries. Quite often these injuries are followed by post traumatic degenerative disorders. One of the most frequent injuries of the knee is torn meniscus.

The meniscus of the knee is a crescent—shaped pad of tough, rubbery fibrocartilage. The paired menisci of the humane knee are often referred to as a “cartilage”. They exist between the femur (thigh bone) and tibia (shin bone) to cushion the knee joint during everyday use, and to provide a lubrication and stability to the knee joint. According to many scientific publications our menisci do age and ultimately degenerate. While they can be suddenly torn apart by a violent injury at any age, they typically become gradually weakened, worn and broken down by natural processes with aging.

Only the outer (more peripheral) 30-40% of meniscus actually has a capillary blood supply and thereby a significant potential for healing when injured. The blood supply to the structure is from a network of small vessels which penetrate from the wider outer rim. Here the blood supply is rich and healing is facilitated. On the inner, sharper rim, however, the blood vessels do not penetrate at all. The cells of the meniscus are dependent on any nourishment they can get from the joint liquid. Tears here do not heal. Since a majority of traumatic tears occur in an avascular area (non-bleeding “white” zone, which is in the inner ⅔ of the meniscus), these tears are rarely good candidates for surgical repairs.

Once thought of as a needless remnant tissue in the knee joint, the torn meniscus was frequently removed by surgery. Over a past few years, it become clear that the meniscus plays a crucial role in the knee joint.

The lateral meniscus is more O-shaped and quite highly mobile, able to slide forwards and backwards with knee movement. The medial meniscus is quite different. It is larger and more C-shaped and tightly bound to the capsular structures and to the medial collateral ligament along the outer rim. It moves very little with the movement of the knee. It is this inflexibility which leads to the medial meniscus being torn more frequently than the lateral meniscus.

In the meniscus, the bounds of fibers run in different directions to offer maximum resistance to tension and to support the relatively massive body weight. Once there is tear, this support mechanism breaks down and the whole internal knee structure is affected.

There are several options available today for torn meniscus treatment, and all of them have their shortcomings and limitations.

Meniscus removal: the joint looses lubricity and stability, and only after 3 weeks of surgery arthrosis in the joint starts to develop.

Partial meniscus removal: since most cases of torn meniscus happen in the load-bearing section of meniscus, removal of this part contributes to loss of joint stability and a cushioning effect between femur and tibia. Damaged meniscus is prone to additional tear and split.

Torn meniscus is repaired by suture: if the tear happened in the non-load-bearing part of the meniscus, where nutrients supply is much better than in so-called “white” zone (peripheral part), it is often possible to repair torn meniscus by suture. Since most cases involve the “white” zone, this option does not have a wide use.

Meniscus transplant: the meniscus is transplanted from a cadaver. There are many techniques published to overcome the autoimmune reaction, but it is still a problem, and post-surgery rehabilitation requires 16 weeks regiment.

Scaffold implant: resorbable plastic parts, or modified animal parts are implanted to help the removed meniscus to grow back. Many publications describe problems connected with this approach.

Implanted inserts: there are many patents describing various inserts to replace meniscus, some of them involve metal and plastic parts, like cobalt steel, polypropylene, nylon, silicone rubber, Teflon and even hydrogels, none of threes can replace the meniscus function. High lubricity of all parts of meniscus and articulate cartilage is required for a proper long-tern function, as well as a cushioning effect.

The present invention process utilizing a unique method of processing polacrylonitrile, and the resulting products, overcome the shortcomings of the above procedures and products. Polyacrylonitrile (PAN) is very interesting and highly versatile polymer. Its carbon-carbon backbone guaranties high biostability and resistance to degradation. PAN is produced by polymerization of acrylonitril monomer, resulting usually in a granulated or powder form. The powder itself would have a little use in the industry, so it must subsequently be processed into another form. One of such forms is acrylic fiber, well known in apparel industry. The same acrylic fiber may be oriented and heat-treated to obtain well-known carbon fiber, a very strong and durable material.

PAN is difficult to process by conventional hot-melt processing methods, because its theoretical melting temperature is above 300° C., and its decomposition temperature is about 175° C.

PAN is usually processed by dissolving the polymer in a suitable solvent at room temperature or at elevated temperatures, to create a solution, such as in DMSO, DMF, NaSCN, Nitric Acid, CaSCN, or Ethylene Carbonate. The PAN solution is then subjected to processing, such as molding or extrusion, and then remaining solvent may be extracted, e.g. in water, and subsequent water evaporation. But PAN can be processed in this way only in a low polymer concentrations, up-to about 15% because the solution viscosity is high and it is difficult to create such a solution without generating air bubbles. Trapped air bubbles will result in weakened polymeric structure and uneven composition. In addition, sometimes it is advantageous to compound filler into the PAN polymer, such as barium sulfate, metal powders or other fillers, e.g. for radio-opacity in medical application of the knee meniscus implant for quality control, peripheral movement and/or future noninvasive examination of product integrity. Such fillers will further increase the solution viscosity and make processing even more difficult. The resulting dry product will also have relatively poor mechanical properties and a high rate of shrinkage due to low polymeric concentration and high solvent concentration.

For all these and other reasons, and also due to costs and waste of large amounts of solvent, it is advantageous to process PAN from higher polymeric concentrations than have been traditionally used, in a way that will yield higher quality products with superior physical characteristics.

As stated above, there is a limited number of suitable solvents for PAN, as is well known to those skilled in the art. This characteristic of PAN creates advantages and disadvantages for using PAN to formulate final products. One advantage is having an excellent resistance to most common solvents, such as hydrocarbons, ketones, alcohols and others. The countering disadvantage is that there is a limited selection of solvents for PAN processing.

By the method of the present invention, PAN can be processed by conventional cold casting, or by hot-melt methods, such as extrusion, injection molding, compression molding and others by modifying the conventional solvent systems, so that they perform more like a melting aid, than a conventional PAN solvent system. This can be achieved by changing the conventional solvent into non-solvent for PAN at low temperatures, yet in a manner that it will be a good solvent at elevated temperatures. This process may be used for other polymeric compositions as well, but since PAN is difficult to process by conventional methods without initial co polymerization with other monomers, such as styrene or others, this novel processing method of PAN has a great advantage over conventional processing methods, which use a low polymeric concentrations. The present invention method, therefore, is described as to Polyacrylonitrile (PAN), but the terms “Polyacrylonitrile” and “PAN”, as used herein is meant to include modified and unmodified Polyacrylonitrile, as well as polymer mixture containing Polyacrylonitrile.

Polymeric compositions, obtained by using the present invention method, with its novel solvent system, are very dense and strong; orientable and further processable. Various fillers can be easily compounded into PAN structure during this process, such as colorings, either reactive or pigments, radio-opacity agents, hydroxyl appatite for bone-healing promotion, or any others, which are not soluble in the solvent system, or water.

Even though all above mentioned solvents could be used, or modified for use in this invention, DMSO is preferred, because it has a relatively sharp transition point between being a poor solvent at low temperature and a good solvent at elevated temperature. DMSO is also inexpensive, has very low toxicity level and is not corrosive, compared to some other above-mentioned solvents. Its temperature range of use is high, since pure DMSO will crystallize at 18° C., and its boiling point is around 180° C.

The following examples exemplify the present invention method and products:

### EXAMPLE 1

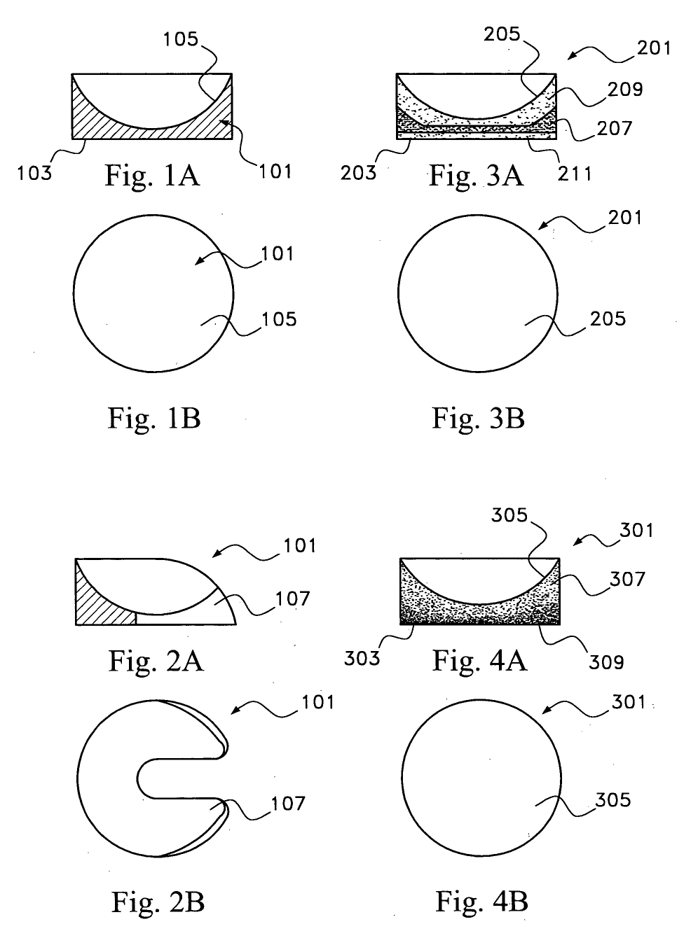

Hydrolyzed Polyacrylonitrile (PAN), supplied by HYMEDIX, NJ, nominal water content 80%, was pulverized into fine powder. The powder was mixed into solution, containing 92% of Dimethyl Sulfoxide (DMSO), 5% Glycerol and 3% water by weight. The polymer/solution ratio was 50% by weight. A closed vessel containing the mixture was rotated to prevent polymer sedimentation for 12 hours at room temperature (RT). The viscous liquid was poured into a round mold, of which one surface was flat, the other convex. The mold was heated at 80 C for 3 hours, let cool down to RT and opened. The resulting article was a clear hydrogel disc with a yellowish tint, one surface flat, the other concave. The disc was washed in water, DMSO extracted. The article was than treated in a mixture of Sulfuric acid and Glycerol, as is known to those skilled in the art, to introduce sulfo-groups to the surface, create a strong negative charge and rapidly increase the water content. The result of this treatment was extremely slippery surface of the disc, similar to a natural cartilage. The disc shape is shown in FIG. 1.

### EXAMPLE 2

An article was prepared as in Example 1. After DMSO extraction and prior the surface treatment, described in Example 1, portion of the disc was cut off, creating the shape of a natural meniscus. The shape is shown in FIG. 2.

### EXAMPLE 3

An article was prepared as in Example 1, only this time a fine Polyester mesh was incorporated into the mold, so the mesh was embedded several millimeters into circumference of the disc, protruding several millimeters outside the disc. The mesh would serve to secure sutures during surgery, but not as a reinforcement of the device. The portion of the disc was than cut off as in Example 2. The surface of the device was treated as described in Example 1.

### EXAMPLE 4

Two polymer/solution mixtures were prepared:

1—Dry hydrogel powder, described in Example 1, was mixed with a solution, described in Example 1, in a ratio of 30% polymer and 70% solution.

2—Mixture prepared as above, only this time the ratio was 60% polymer and 40% solution.

Both mixtures were rotated in closed containers for 12 hours to prevent polymer sedimentation. In the same mold described in Example 1, a layer of first mixture was cast, than a layer of second mixture with increased polymer content was cast over the first layer. Then the first mixture was cast again over the second layer, creating a sort of a sandwich, where a layer of a high concentrated polymer was entrapped in 2 layers of less concentrated polymer. The mold was closed and heated at 80 C for 3 hours, cooled to RT and the article de-molded. After DMSO extraction and a surface treatment, described in Example 1, the resulting article was a structural device, where both the flat and concave surfaces were formed of a softer, but still very strong hydrogel and in between them a rigid, but still flexible core was created. The article is shown in FIG. 3.

### EXAMPLE 5

A structured sandwiched disc was created, as described in Example 4, but this time 2 different polymers at the same concentration were used. One polymer was hydrolyzed to a higher degree, than the other one. Mixtures of both polymers were prepared as in Example 4, but in 50% concentrations. Mold was filled and heated as in Example 4, DMSO extracted and surface treated as in Example 1. Resulting article was very similar as in Example 4.

### EXAMPLE 6

A polymeric mixture was prepared according to Example 1. Into this, 2 micron size Tantalum powder was introduced, 10% by weight. The mixture was again rotated for 12 hours to prevent sedimentation of polymer and metal powder. Mold was filled and further processed as described in Example 1. The resulting article was radio-opaque and well visible under X-Rays examination.

### EXAMPLE 7

One polymeric mixture was prepared according to Example 1, second polymeric mixture according to Example 6. The mold was filled and treated as in Example 4, where the layer containing Tantalum was entrapped in layers of clear hydrogel. Processed as in Example 4, the resulting article had a radio-opaque core.

### EXAMPLE 8

A mixture of polymer and solution was prepared as in Example 1. Mold was filled, closed, and let sit at RT for 30 minutes. This step provided for a controlled sedimentation of polymer particles to the bottom of the mold. The mold was then processed as described in Example 1. The resulting article had a gradually increased water content, decreased density and stiffness from the flat bottom surface of the disc to the concave surface. This process produced an article with a bottom part reinforced by a high polymer concentration and the upper part for a better cushioning effect. Shown on FIG. 4.

### EXAMPLE 9

PAN flakes were prepared where 50% polymer powder by weight was mixed with a solution mixture of DMSO, 92% and Glycerol, 8%. Aluminum mold, described in Example 1, was filled with resulting flakes and pressed in a heated press at 150 C. When PAN dissolved and polymer started to overflow the mold, the mold was cooled down to RT, article de-molded, DMSO extracted in water. The molded article was immersed in Sulphuric acid, diluted to 65% and hydrolyzed until it reached a predetermined size, which controlled the degree of hydrolysis. The desired equilibrium water content of the article was 45-50%. The acid was extracted in water; article neutralized with 3% Soda Bicarbonate, which was again extracted in water. The surface of the article was treated as in Example 1. The result was a strong, flexible hydrogel disc with a very lubricous surface.

### EXAMPLE 10

PAN disc was molded as in Example 9. After DMSO extraction, the article was immersed in 4% solution of Sodium Hydroxide (NaOH) and hydrolyzed at 20 C, until it reached predetermined size, which controlled the degree of hydrolysis. NaOH was extracted and article soaked in isotonic sodium chloride solution, in which the article equilibrium water content reached 60%. The resulting article was a strong, flexible hydrogel disc with a highly negatively charged surface, producing a good degree of lubricity.

Reference is made to the drawings, wherein:

FIGS. 1A and 1B illustrate a hydrogel disc 101, with one side 103 flat, and the other side 105 concave. The profile is circular. FIG. 1A shows that a single material was used to create the disc. FIGS. 2A and 2B show disc 101, as in FIGS. 1A and 1B, except wherein these Figures show a cut “horseshoe section” 107, i.e., a knee meniscus implant.

FIGS. 3A and 3B illustrate a sandwiched structure of the disc 201, wherein there is a less dense hydrogel area 207 and high density areas 209 and 211 above and below, and being of the same hydrogel material as area 207. It may be cut into a knee meniscus implant as described.

FIG. 4 shows a hydrogel disc 301 wherein a high density hydrogel 309 forms top concave layer 305, and low density hydrogel 307 forms flat, bottom layer 303. These layers were created in the device from the same hydrogel material via a controlled sedimentation process. The disc 301 may be cut into a knee meniscus implant as described.

Obviously, numerous modifications and variations of the present invention are possible in light of the above teachings. It is therefore understood that within the scope of the appended claims, the invention may be practiced otherwise than as specifically described herein.

What is claimed is:

1. A method of making a lubricious polyacrylonitrile knee meniscus implant a predetermined form, which comprises:
(a) preparing a first solution of (i) a room temperature solvent that will dissolve polyacrylonitrile at room temperature, and, (ii) a room temperature non-solvent that will not dissolve polyacrylonitrile at room temperature, said first solution being prepared with sufficient of said non-solvent to render said room temperature solvent inoperable such that it will not dissolve polyacrylonitrile at room temperature and such that it will be operable at temperatures above 65° C. to dissolve polyacrylonitrile therein;
(b) combining polyacrylonitrile with said first solution to form a mixture, in an amount of at least 20%, by weight, of polyacrylonitrile, based on the total weight of the mixture;
(c) heating said mixture at temperatures in excess of 65° C. to produce a fluid polyacrylonitrile product and processing said fluid polyacrylonitrile product in a mold of an artificial joint component of a predetermined form;
(d) cooling said mold and fluid polyacrylonitrile product to create a knee meniscus implant.

2. The method of claim 1 wherein said room temperature solvent is selected from the group consisting of dimethyl sulfoxide, dimethyl formamide, NaSCN, CaSCN, nitric acid, ethylene carborate and mixtures thereof.

3. The method of claim 1 wherein said non-solvent is selected from the group consisting of water, miscible liquid carbon compounds that do not dissolve polyacrylonitrile, and combinations thereof.

4. The method of claim 3 wherein said carbon compounds are selected from the group consisting of liquid straight chain hydrocarbons, liquid ring hydrocarbons, liquid ring-straight chain hydrocarbons, and mixtures thereof.

5. The method of claim 1 wherein said non-solvent is selected from the group consisting of glycol, miscible liquid alcohols, liquid ketones, sugars and combinations thereof.

6. The method of claim 1 wherein said processing step (c) is a processing step utilizing a mold having a generally circular shape with one surface flat and the other convex, and the resulting product is subsequently cut into a crescent shape.

7. The method of claim 1 wherein said method further includes the step of (e) treating the resulting product chemically to increase its surface hydrophilicity.

8. The method of claim 7, further including the steps of removing solvent from said rigid artificial joint component by liquid extraction before treating to increase its surface hydrophilicity.

9. The method of claim 1 wherein said first solution contains about 40% to 98% of said room temperature solvent and about 60% to 2% of said room temperature non-solvent, by weight, based on the weight of said room temperature solvent and said room temperature non-solvent.

10. The method of claim 1 wherein said first solution contains at least 50%, by weight, of room temperature solvent, based on the weight of said room temperature solvent and said room temperature non-solvent.

11. The artificial joint component resulting from the method of claim 1.

12. The artificial joint component resulting from the method of claim 2.

13. The artificial joint component resulting from the method of claim 3.

14. The artificial joint component resulting from the method of claim 4.

15. The artificial joint component resulting from the method of claim 5.

16. The artificial joint component resulting from the method of claim 6.

17. The artificial joint component resulting from the method of claim 7.

18. The artificial joint component resulting from the method of claim 8.

19. The artificial joint component resulting from the method of claim 9.

20. The artificial joint component resulting from the method of claim 10.
